(19) United States
(12) Patent Application Publication
(10) Pub. No.: US 2025/0310141 A1
(43) Pub. Date: Oct. 2, 2025

(54) SECURE VIDEO CONFERENCE SYSTEM BETWEEN ISOLATED NETWORKS

(71) Applicant: RAFAEL ADVANCED DEFENSE SYSTEMS LTE., Haifa (IL)

(72) Inventor: Eliran TAMIR, Haifa (IL)

(21) Appl. No.: 19/089,158

(22) Filed: Mar. 25, 2025

(30) Foreign Application Priority Data
Mar. 26, 2024 (IL) 311726

(51) Int. Cl. H04L 12/18

(52) U.S. Cl. CPC H04L 12/1822; H04L 12/1818; H04L 12/1827

(57) ABSTRACT

A secure video conferencing system designed to operate within isolated network environments, ensuring secure and efficient communication without direct network connectivity between segregated systems. The system includes a workstation configured to initiate video conferencing sessions, a client computer associated with an organization's main or isolated network, and security isolators that mediate unidirectional data flow between these components. The security isolators prevent unauthorized bidirectional data exchange, ensuring strict cybersecurity protocols are maintained.

### FIELD OF THE INVENTION

The invention pertains to the field of digital communication systems. More specifically, the invention relates to video conferencing technologies that focus on a video conference system that operates between isolated networks, where direct data communication between these networks is either restricted or non-existent.

### BACKGROUND OF THE INVENTION

In the realm of digital communication, video conferencing has become an indispensable tool for personal and professional communication. However, existing video conferencing systems rely heavily on the ability to transmit data across interconnected networks. This dependency limits their utility in scenarios where networks are intentionally isolated for security, privacy, or regulatory reasons. For instance, government agencies, research facilities, and certain corporate environments often operate within highly secure and isolated networks to protect sensitive information. In such cases, conventional video conferencing systems fail to provide a solution, as they cannot bridge the gap between these isolated networks without compromising their integrity or security.

The primary challenge addressed by this invention is the lack of a viable video conferencing solution that can operate between isolated networks without the need for direct data communication between these networks. Existing systems either cannot function in such environments or require compromises in network isolation, leading to potential security vulnerabilities. This invention aims to provide a secure, efficient, and reliable means of conducting video conferences between parties operating on isolated networks, thereby facilitating communication without risking the integrity of each network's security protocols.

It is an object of the present invention to provide a video conferencing system that can be employed between isolated networks.

It is another object of the invention to ensure that the system maintains the integrity and security of each network, without the need for direct data communication between them.

It is yet an object of the invention to provide a solution that is user-friendly and technologically robust, capable of delivering high-quality video and audio transmission.

It is still another object of the invention to create a system that can be easily integrated into existing network infrastructures, requiring minimal modification or compromise to the network's security measures.

It is another object of the invention to address the specific needs of organizations and entities that operate within secure and isolated network environments, thereby broadening the scope and applicability of video conferencing technology.

Other objects and advantages of the invention will become apparent as the description proceeds.

### SUMMARY OF THE INVENTION

A secure video conferencing system for isolated network environments, comprising:
a network interface module designed to facilitate communication with isolated networks;
one or more security units, each configured to restrict bidirectional data exchange and ensure one-way data transmissions within and across said isolated networks;
a video and audio processing unit capable of handling and transmitting video and audio data; and
a user interface for enabling users to interact with the video conferencing system.

In one aspect, the network interface module is configured to initiate a video conference session.

In one aspect, the user interface is configured to detect incoming calls in real-time, and upon identifying an incoming call, to execute a series of predefined actions, tailored to enhance the user experience during the call.

In one aspect, the security unit employs one way flow of audiovisual data, wherein the one way flow includes a HDMI to USB conversion of the audiovisual data.

In one aspect, the video and audio processing is configured to interface with a telecommunication application.

In another aspect, the invention relates to a method for conducting video conferencing in isolated network environments, the method comprising:
initiating a video conference session via a network interface module;
enabling one-way video and audio data flow transmission through one or more security units configured to prevent bidirectional data exchange;
processing said video and audio data through a video and audio processing unit; and
displaying the video conference through a user interface.

In one aspect, initiating a video conference session involves submitting a request to schedule a meeting via the user interface that includes selected infrastructure for the meeting, verifying by a primary server the video conference session data to ensure availability, and once the session data is validated, generating a meeting link for a voice over Internet Protocol (VoIP) software application through a service configured to handle the creation of VoIP meeting, storing the meeting details in a database, generating a meeting invitation to notify all participants, wherein the meeting invitation includes the selected infrastructure, and creating schedule tasks to bring up the selected infrastructure for the meeting.

In one aspect, establishing a conversation for the initiated video conference session involves communication between the primary server and an intra-organizational computer of the isolated network, via a dedicated application layer configured to take over the VoIP software application.

In one aspect, establishing the video conference session involves upon receiving an incoming call from an external client computer to the intra-organizational computer, automatically answering the incoming call, via the network interface module that automates the call.

In yet another aspect, the present invention relates to a secure video conferencing system for isolated network environments, comprising:
a workstation configured to initiate and participate in a video conferencing session;
a client computer associated with an isolated network of an organization;
at least one security isolator configured to enforce unidirectional data flow between the client computer and the workstation, preventing bidirectional data exchange; and
a server infrastructure, communicatively linked to the client computer, configured to manage virtual meeting scheduling and execution.

In one aspect, a dedicated application running on the workstation, configured to interface with a virtual meeting platform (VMP), execute automated session joining, and control audiovisual settings.

In yet another aspect, the present invention relates to a method for conducting a secure video conference in an isolated network environment, comprising:
receiving a request to initiate a video conferencing session between a workstation and a client computer in an isolated network;
configuring a security isolator to enforce unidirectional data flow between the workstation and the client computer;
launching a dedicated application on the workstation to interface with a virtual meeting platform (VMP);
establishing a secure video communication session without direct network connectivity between the workstation and the client computer; and
executing automated meeting controls, including camera activation, session joining, and screen transitions, based on commands received from a server infrastructure.

### BRIEF DESCRIPTION OF THE DRAWINGS

FIG. 1 schematically illustrates secure video conference system between isolated networks, according to an embodiment of the invention;

FIG. 2 schematically illustrates a video conference session by focusing on the system's main network its isolated segments, according to an embodiment of the present invention;

FIG. 3 schematically illustrates additional components of the system, according to an embodiment of the invention;

FIG. 4A schematically illustrates the setting up of a meeting invitation process of system 100, according to an embodiment of the invention;

FIG. 4B schematically illustrates the conversation establishing process of the system, according to an embodiment of the invention; and

FIG. 4C schematically illustrates the call process, according to an embodiment of the invention.

### DETAILED DESCRIPTION OF THE INVENTION

An organization network often encompasses a complex structure of interconnected systems and devices, facilitating communication, data sharing, and operational efficiency. Within such a network, an isolated network—or “air-gapped” network—plays a crucial role in enhancing security. This segregated section is deliberately kept offline or physically separated from the organization's main network and the internet to protect sensitive data or critical systems from cyber threats, unauthorized access, and malware. By employing an isolated network, organizations can ensure an extra layer of security for their most sensitive operations, limiting the risk of external breaches and internal leakages. The present invention seeks to fill a significant gap in the current digital communication landscape, offering a novel approach to video conferencing that respects and upholds the stringent security requirements of isolated network environments.

The invention presents a novel video conferencing system designed to operate efficiently and securely within isolated network environments. The system comprises several components that are configured to form together a secure video conferencing infrastructure, each component playing a crucial role in facilitating seamless video communication without direct data exchange between the isolated networks.

Through this description, the term ‘Virtual Meeting Platform’ (VMP) refers to a digital communication tool, such as Skype, Google Meet, Zoom, and others, that are engineered to enable synchronous audio-visual interactions among users across disparate geographic locales via the internet. VMPs leverage technologies such as Voice over Internet Protocol (VoIP) and other suitable protocols to facilitate real-time voice and video communications. These platforms are designed to support a wide array of functionalities including, but not limited to, conducting virtual meetings, seminars (webinars), instantaneous messaging, and collaborative tasks. By doing so, VMPs play a crucial role in facilitating remote work, digital learning environments, and virtual social engagements, underscoring their versatility and essentiality in digital communication infrastructures.

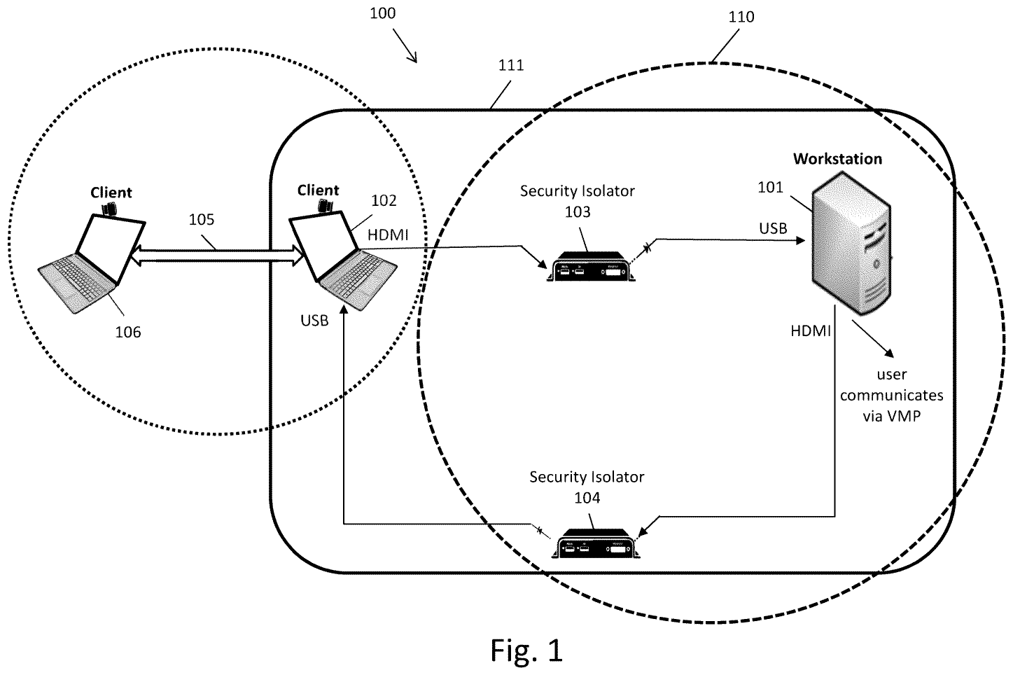

FIG. 1 schematically illustrates secure video conference system 100 between isolated networks, according to an embodiment of the invention. System 100 comprises a workstation 101 through which a user may start a conversation (e.g., the user may start a conversation with workstation 101 on an isolated network 110 of a first organization, using VMP such as Skype or other suitable 3^{rd} party digital communications software application), a client computer 102 that is part of the first organization main network 111 (and can be included in its isolated segments) is configured for accepting calls only, security isolators 103, 104 configured to prevent vulnerable peripherals in the isolated network 110 from mediating between compromised and secure computers by enforcing unidirectional data flow between the client computer and the workstation, preventing bidirectional data exchange and thereby ensuring that video, audio and data flows in a single direction. According to an embodiment of the invention, each security isolator is a security unit that physically prevents any return data from being transmitted back into the originating network, thus each security isolator operates as a unidirectional gateway, thereby ensuring no reverse communication is possible. In this embodiment, the first security isolator 103 mediate data flow in a single direction from client 102 (e.g., via a HDMI output of client 102) to workstation 101 (e.g., via a USB port of workstation 101 as an input), and the second isolator 104 mediate data flow in a single direction from workstation 101 (e.g., via a HDMI output of workstation 101) to client 102 (e.g., via a USB port as an input of client 2).

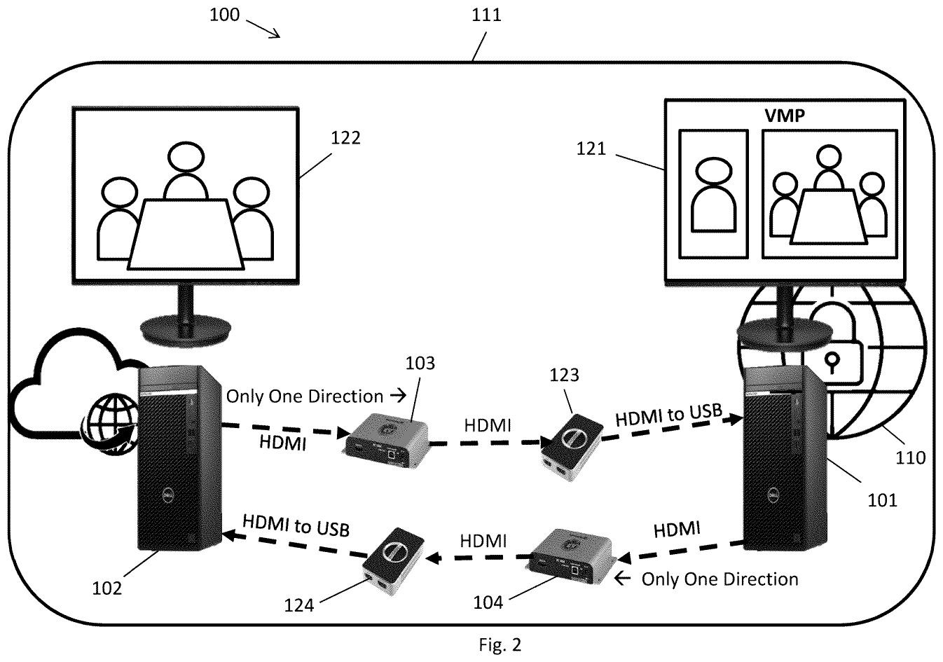

According to an embodiment of the invention, each security isolator 103, 104 act as a one way intermediary device and it may comprise a conversion unit configured to transform audiovisual signals from an output format of one device into an input format of another device, such as an HDMI to USB unit, or the conversion unit, such as the HDMI to USB can be provided as a separate unit. The data flow mechanism is designed to transmit audiovisual content between two computer systems (i.e., client 102 and workstation 101), e.g., by leveraging an HDMI output on the source computer and a USB input on the destination computer. The process initiates with the source computer dispatching its audiovisual output via an HDMI interface, a standard for high-definition digital transmission. This signal is then directed through an HDMI cable to security isolator 103 (in an inbound direction, i.e., from client 102 to workstation 101), and through security isolator 104 (in an outbound direction, i.e., from workstation 101 to client 102). In some embodiments, each security isolator 103, 104 is tasked with the function of converting the HDMI signal into a USB-compatible format, thereby enabling the seamless transmission of data over a USB interface. Subsequently, a USB cable facilitates the transfer of this converted digital content to the destination computer, which receives and processes the data through its USB port. In other embodiments, the HDMI to USB conversation is done by a dedicated unit separated from each security isolator 103, 104 (as shown in FIG. 2).

As aforementioned, client 102 can be part of the main network 111 of the first organization, and it can be included as part of the isolated network 110 of the first organization. Client 102 is adapted to connect with an external client computer 106 via a dedicated line 105 that is separated from the main network 111. Client computer 106 is not part or not belong to the main network 111 of the first organization (e.g., it can be belong to other network or a second organization). In other words, external client computer 106 refers to a computing device that is not part of the first organization's main network 111 infrastructure or its isolated segments. This type of client operates outside the first organization's internal network boundaries and may connect to client 102 via the internet or other external networks through dedicated line 105. External clients, such as client computer 106, can be personal devices, computers belonging to other organizations, or public computers. In this embodiment, they may interact with the organization's isolated network 110 for video conference purposes only.

FIG. 2 schematically illustrates a video conference session by focusing on the main network 110 of system 100 and its isolated segments, according to an embodiment of the present invention. In this embodiment, in addition to the components shown in FIG. 1, the following components are shown: HDMI to USB converters 123, 124, a display unit 121 of client workstation 101, and a display unit 122 of client 102. In addition, a more detailed view of the one direction data flow between client 102 and workstation 101 are also shown in this figure.

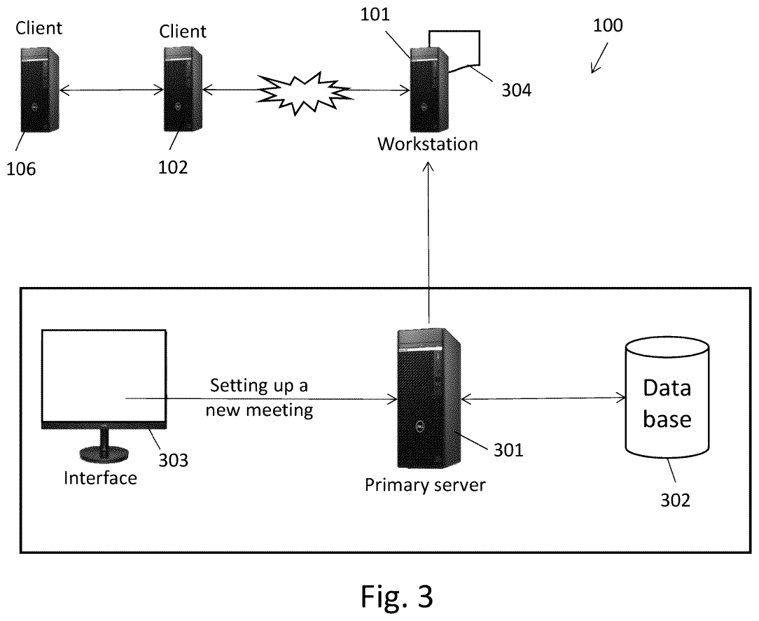

Despite the lack of direct network communication, system 100 handles a secure video conference system between isolated networks. FIG. 3 schematically illustrates additional components of system 100, according to an embodiment of the invention. For enabling a secure video conference session without a direct network communication, system 100 manages on workstation 101 a dedicated software application 304 (i.e., an application layer) specifically engineered to interface with VMP (e.g., Skype, Google Meet, Zoom, and the like). This dedicated application 304 is meticulously designed to perform a range of critical functions, including the automated joining of VMP conversations, the activation and control of the webcam, the seamless transition to full-screen mode for an immersive communication experience, etc.

In parallel to this local software setup, there exists a server infrastructure, which may virtually run on workstation 101, or alternatively provided as a separate dedicated server. This dedicated server is strategically configured to maintain a continuous listening state, ready to receive and interpret commands issued from a primary server 301. Upon receipt of such commands, the dedicated server acts as an intermediary, effectively translating and forwarding these commands to the VMP-interfacing software (i.e., dedicated application 304) residing on workstation 101.

Within the organization network infrastructure, primary server 301 plays a pivotal role in the centralized management of virtual meetings. It is expressly designed to aggregate and maintain a comprehensive schedule of upcoming virtual meetings, which may include various details such as meeting times, participants, and the respective VMP communication platforms to be used, such as Skype Google Meet, Zoom, etc.

This server is equipped with software algorithms capable of processing the collected meeting information and determining the necessary actions for each endpoint within the organization network. Based on this analysis, primary server 301 generates specific commands tailored to each computer's requirements within the organization network.

These commands are then disseminated across the organization network to the designated computers, instructing them to initiate the necessary protocols for joining the scheduled meetings. This process involves a series of automated steps, such as launching the appropriate VMP communication application (e.g., Skype), configuring the necessary audio and video settings, and connecting to the designated virtual meeting space at the predetermined time.

The role of primary server 301 extends beyond mere command dispatch; it also includes monitoring the status of each command execution, ensuring that the computers successfully connect to the meetings as intended. This comprehensive approach ensures a seamless and efficient orchestration of virtual meetings across the corporate network, minimizing manual intervention and enhancing the productivity of the organization's virtual communication processes.

According to an embodiment of the invention, the architecture of system 100 is further augmented by the integration of a database 302, meticulously designed to serve as a centralized repository for storing an extensive array of information pertinent to meetings and the underlying network infrastructure. Database 302 is structured to accommodate comprehensive records of all scheduled meetings, encapsulating vital details such as meeting identifiers, scheduled times, participants, agenda items, and specific platform links for VMP services like Skype, Google Meet, Zoom, etc. This information is systematically cataloged to facilitate easy retrieval and management, enabling system 100 to efficiently orchestrate and monitor meeting logistics across the corporate network.

In addition to meeting information, database 302 may also engineered to store detailed infrastructure data, which includes but is not limited to network topology, device configurations, user permissions, and system settings. This infrastructure information can be used for ensuring a seamless integration and operation of the network components, providing the foundational data necessary for primary server 301 to make informed decisions regarding resource allocation, security protocols, and communication channel optimization.

The inclusion of database 302 in the architecture of system 100 not only enhances the robustness and scalability of the meeting management process but also contributes to a more resilient and adaptive network infrastructure. By centralizing the storage of meeting and infrastructure data, system 100 ensures that all components operate cohesively, maintaining high levels of efficiency and reliability in the corporate communication ecosystem.

System 100 further comprises a call ordering interface 303, which can be part of a dedicated website established for ordering video calls of this type for users of the organization. According to an embodiment of the invention, call ordering interface 303 is a user interface component designed to streamline the process of scheduling video calls. This interface is seamlessly integrated into a dedicated website, specifically developed to cater to the needs of the organization's users. The website serves as a centralized platform where users can effortlessly schedule, modify, and manage video calls tailored to their requirements.

Call ordering interface 303 is meticulously designed to provide an intuitive and user-friendly experience, enabling users to navigate through the process of setting up video calls with ease. Users can access a comprehensive suite of features, including selecting participants, setting call times, specifying call agendas, and choosing the preferred video conferencing platform. The interface is also equipped with advanced functionalities such as conflict detection, where it automatically identifies and alerts users to potential scheduling conflicts, ensuring optimal timing for all participants.

Behind the scenes, the call ordering interface interacts with the system's underlying database and server infrastructure to process and store the details of each scheduled video call. This integration ensures that once a call is ordered through the interface, its details are immediately propagated throughout the system, triggering the necessary preparations for the scheduled video conference. This includes allocating resources, notifying participants, and setting up the required communication channels within the corporate network.

The establishment of this dedicated website and its integrated call ordering interface represents a strategic enhancement to the organization's communication infrastructure. It not only simplifies the process of scheduling and managing video calls but also contributes to a more organized, efficient, and collaborative working environment for the users of the organization.

According to an embodiment of the invention, client 102 includes an automation script, engineered to detect incoming calls in real-time. Upon identifying an incoming call, this script is capable of executing a series of predefined actions, tailored to enhance the user experience during the call. One notable example of such an action is the automated initiation of full-screen mode for the call interface, thereby optimizing the visual aspect of the communication session. This automation script may operate by continuously monitoring the system's communication channels for signals indicative of incoming calls. The script is designed to discern these signals amidst the myriad of data flows within the network, ensuring accurate and timely detection of incoming calls.

Once an incoming call is detected, the script instantiates a set of commands that eventually interface with the relevant VMP call handling software in use within the organization. These commands are meticulously crafted to manipulate the application's interface, enabling it to transition seamlessly to full-screen mode. This transition is designed to occur automatically, without the need for manual intervention by the user, thereby providing a more immersive and focused communication experience.

This orchestrated system 100 ensures a robust and responsive interaction with VMP, enabling advanced control and management of communication features, thereby enhancing the overall user experience and operational efficiency.

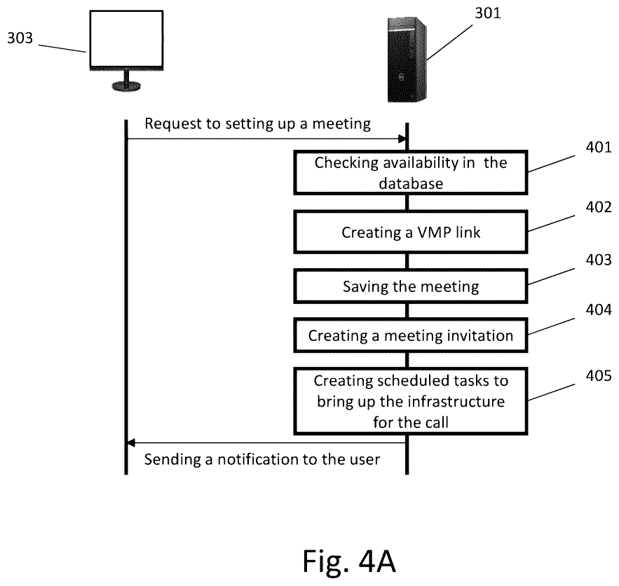

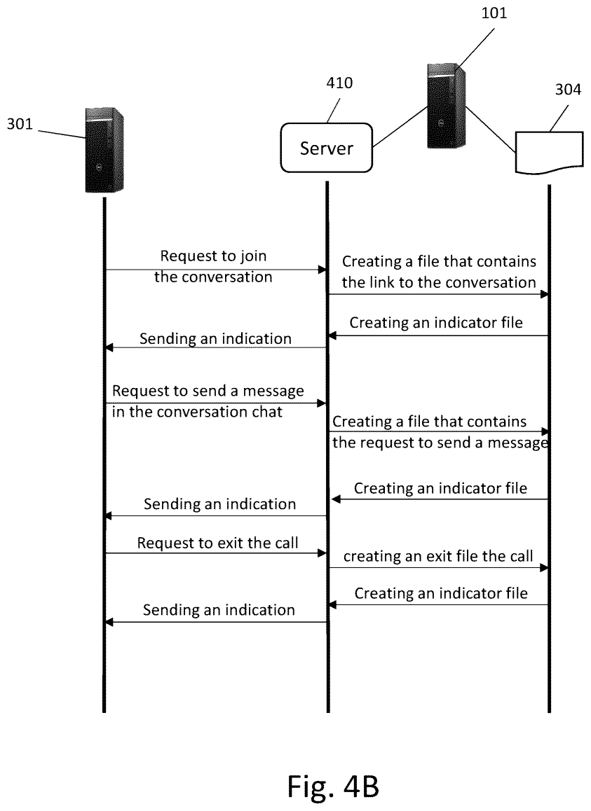

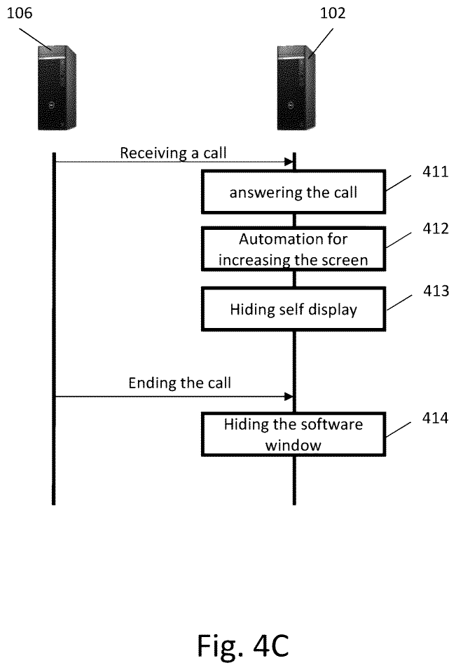

FIG. 4A schematically illustrates the setting up of a meeting invitation process of system 100, according to an embodiment of the invention. Through the call ordering interface 303, participants can request to schedule a meeting by selecting the necessary infrastructure and inviting other users for an available date. Upon submission the request, the primary server 301 verifies the session information with the system's database 302 to ensure availability (step 401). For instance, once the data is validated, a meeting link for the VMP software application is generated (e.g., a suitable URL or web address that provides access to a virtual meeting room of the VMP). According to an embodiment of the invention, the link can be generated by making an HTTP REST request to a service within the organization that handles the creation of VMP meeting (step 402).

The meeting details are then stored in the database 302 (step 403), and a meeting invitation is generated (step 404), e.g., by using Outlook, to notify all participants and include the selected infrastructure in the meeting information (step 405). In step 405, primary server 301 creates scheduled tasks to bring up the infrastructure for the call.

For example, if the meeting is scheduled for the same day as the request, the system creates jobs on a repeating schedule and automatically sends commands to the organization's computers (e.g., by Cron jobs using cron Unix-based command-line utility). These commands prompt the computer to join the VMP meeting, leave it when necessary, and post a closing message in the meeting chat at the end.

FIG. 4B schematically illustrates the conversation establishing process of system 100, according to an embodiment of the invention. Communication between the primary server 301 side and the intra-organizational computer (workstation 101) is carried out using REST, which includes several commands to the server running on this computer (e.g., a server 410 running on workstation 101). Server 410 communicates with the application layer 304 that takes over the VMP (e.g., by using Microsoft's Lync SDK), using files that describe the desired operation. The above conversation establishing process may involve the following procedures:
Sending a request to join the conversation from primary server 301 to server 410;
Creating a file that contains the link to the conversation;
Creating an indication file by application layer 304 and sending it to the primary server 301 via server 401;
Generating, by primary server 301, a request to send a message in the conversation chat. The request is received by server 410 and communicated to application layer 304 for creating a file that contains the request to send a message, and sending;
Upon creating the file that contains the request to send the message, creating an indicator file and sending the indication to primary server 301, via server 410;
Upon completing conversation, sending a request to exit the call, and accordingly creating a file that contains the request to exit the call; and
Sending an indication of the exit to primary server 301.

FIG. 4C schematically illustrates the call process when the computer is disconnected, according to an embodiment of the invention. For example, in this embodiment, a representative dials from client 106 (e.g., via VoIP by using a conference phone such as a Polycom) to a computer in the organization, such as to client 102. Client 102 automatically answers the call (via a network interface module 411, which is a software-based call agent of system 100 that runs on client 102), and the script (e.g., written in Python), automates the call. Optionally, the script may increase the call screen (412), hide the display (413), and at the end of the call hide the software call agent running on client 102 (414).

As will be appreciated by a skilled person, the arrangement described in the figures results in a system that provides a significant advancement in the field of digital communication, particularly in addressing the challenges faced by entities operating within isolated or highly secure network environments. Its innovative approach and robust design make it a pivotal solution for secure and efficient video conferencing, respecting the stringent security protocols of isolated networks. The subsequent addition of detailed descriptions of each component and operational methodology will further elucidate the system's uniqueness and technical superiority.

The terms, “for example”, “e.g.”, as used herein, are intended to be used to introduce non-limiting examples. While certain references are made to certain example system components, other components can be used as well and/or the example components can be combined into fewer components and/or divided into further components. Moreover, all the above descriptions and examples have been given for the purpose of illustration and are not intended to limit the invention in any way. Many different electronic and logical elements can be employed, all without exceeding the scope of the invention.

1. A secure video conferencing system for isolated network environments, comprising:
a) a network interface module designed to facilitate communication with isolated networks;
b) one or more security units, each configured to restrict bidirectional data exchange and ensure one-way data transmissions within and across said isolated networks;
c) a video and audio processing unit capable of handling and transmitting video and audio data; and
d) a user interface for enabling users to interact with the video conferencing system.

2. The system of claim 1, wherein the network interface module is configured to initiate a video conference session.

3. The system of claim 1, wherein the user interface is configured to detect incoming calls in real-time, and upon identifying an incoming call, to execute a series of predefined actions, tailored to enhance the user experience during the call.

4. The system of claim 1, wherein the security unit employs one way flow of audiovisual data.

5. The system of claim 4, wherein the one way flow includes a HDMI to USB conversion of the audiovisual data.

6. The system of claim 1, wherein the video and audio processing is configured to interface with a telecommunication application.

7. A method for conducting video conferencing in isolated network environments, the method comprising:
a) initiating a video conference session via a network interface module;
b) enabling one-way video and audio data flow transmission through one or more security units configured to prevent bidirectional data exchange;
c) processing said video and audio data through a video and audio processing unit; and
d) displaying the video conference through a user interface.

8. The method of claim 1, wherein initiating a video conference session involves submitting a request to schedule a meeting via the user interface that includes selected infrastructure for the meeting, verifying by a primary server the video conference session data to ensure availability, and once the session data is validated, generating a meeting link for a voice over Internet Protocol (VOIP) software application through a service configured to handle the creation of VoIP meeting, storing the meeting details in a database, generating a meeting invitation to notify all participants, wherein the meeting invitation includes the selected infrastructure, and creating schedule tasks to bring up the selected infrastructure for the meeting.

9. The method of claim 8, wherein establishing a conversation for the initiated video conference session involves communication between the primary server and an intra-organizational computer of the isolated network, via a dedicated application layer configured to take over the VoIP software application.

10. The method of claim 9, wherein establishing the video conference session involves upon receiving an incoming call from an external client computer to the intra-organizational computer, automatically answering the incoming call, via the network interface module that automates the call.

11. The method of claim 6, wherein the one way video and audio data flow includes HDMI to USB conversion.
